(19) United States
(12) Patent Application Publication
(10) Pub. No.: US 2007/0083623 A1
(43) Pub. Date: Apr. 12, 2007

(54) Mobile terminal apparatus

(76) Inventors: Makoto Nishimura, Tokyo (JP); Yasuka Onishi, Kanagawa (JP)

Correspondence Address: PEARNE & GORDON LLP, 1801 EAST 9TH SRTEET, SUITE 1200, CLEVELAND, OH, 44114-3108, US

(21) Appl. No.: 10/577,502

(22) PCT Filed: Oct. 29, 2004
(86) PCT No.: PCT/JP04/16133

§ 371 Date: Dec. 5, 2006

(30) Foreign Application Priority Data
Oct. 30, 2003 (JP) 2003-370051
Oct. 7, 2004 (JP) 2004-294895
Oct. 7, 2004 (JP) 2004-294902
Oct. 28, 2004 (JP) 2004-3149695

(51) Int. Cl. G06F 15/173

(52) U.S. Cl. 709/223

(57) ABSTRACT

There are provided a storage section 16 for storing transmitted electronic mails and received electronic mails, respectively; a control section 19 for detecting electronic mails exchanged with a party designated by an operation section 6 from the electronic mails stored in the storage section 16; and a display section 1 for displaying in time sequence and in list form the electronic mails exchanged with the other party detected by the control section 19. Thus, the electronic mails transmitted to and received from the designated party can be displayed while being mixed in time sequence and in list form, whereby the manner in which the electronic mails have been exchanged with the other party becomes clearly understood at a glance.

### TECHNICAL FIELD

The present invention relates to a portable terminal apparatus such as a cellular phone having an electronic mail function.

### BACKGROUND ART

In addition to having a phone function, a related-art cellular phone is equipped with many functions such as an electronic mail function, an Internet browsing function, and the like. The cellular phone is configured to store the history of calls in a storage section, as a matter of course, when phone calls are made. The cellular phone is also configured to store the history of electronic mails when electronic mails are exchanged, as well (see, e.g., Patent Document 1).

Consequently, even in the case of the cellular phone, transmitted electronic mails, received electronic mails, and the history of outgoing or incoming phone calls can be respectively displayed and readily ascertained. Patent Document 1: JP-A-11-272585

### DISCLOSURE OF THE INVENTION

However, in a currently-used cellular phone of this type, transmitted electronic mails and received electronic mails are displayed while being distinguished from each other. For instance, even when electronic mails have been exchanged with the same party on the other end, transmitted electronic mails and received electronic mails cannot be displayed in a mixed manner. This also applies to the history of outgoing calls and the history of incoming calls of the phone. For example, considerable inconvenience is encountered in relation to, e.g., in the manner which phone calls have been made to the same party on the other end.

The present invention has been conceived in light of such a conventional problem, and provides a portable terminal apparatus capable of readily, accurately displaying exchange of electronic mails and phone calls in time sequence.

A portable terminal apparatus of the present invention comprises a storage unit that stores a transmitted electronic mail and a received electronic mail; a telephone directory storage unit that stores registration information including at least one of a name, a phone number, and a mail address; a designation unit that designates a party on the other end from the stored registration information; a detection unit that reads and detects, from the storage unit, an electronic mail related to the other party designated by the designation unit; and a display unit that displays the electronic mails related to the other party detected by the detection unit so that the transmitted electronic mail and the received electronic mail are displayed while being mixed in list form and in time sequence.

By the above configuration, the electronic mails transmitted to the designated party and the electronic mails received from the same can be displayed while being mixed in list form and in time sequence. Hence, the manner in which the electronic mails have been exchanged with the designated party is clearly seen at a glance.

A portable terminal apparatus of the present invention comprises a storage unit that stores a transmitted electronic mail and a received electronic mail; a designation unit that designates a desired electronic mail from the stored electronic mail; a detection unit that reads and detects, from the storage unit, an electronic mail exchanged with the other party that is the same party with whom the electronic mail designated by the designation unit is exchanged; and a display unit that displays the electronic mails detected by the detection unit so that the transmitted electronic mail and the received electronic mail are displayed while being mixed in time series and in list form.

By the above configuration, the electronic mails transmitted to the designated party and the electronic mails received from the same can be displayed while being mixed in list form and in time sequence. Hence, the manner in which the electronic mails have been exchanged to the designated party is dearly seen at a glance.

The portable terminal apparatus of the present invention has such a configuration that the display unit displays titles of the electronic mails in list form as the list-form display.

By the above configuration, simply-described titles can be displayed in list form. Hence, the nature of the transmitted and received electronic mails can be readily grasped.

A portable terminal apparatus of the present invention comprises a storage unit that stores a history of outgoing calls and a history of incoming calls; a detection unit that detects the history of outgoing calls and the history of incoming calls with regard to a party designated by designation unit from the histories of outgoing calls and the histories of incoming calls stored in the storage unit; and a display unit that displays the history of outgoing calls and the history of incoming calls while being mixed, the histories being detected by the detection unit in time series and in list form.

By the above configuration, the history of outgoing calls and the history of incoming calls pertaining to the designated party can be displayed while being mixed in time series and in list form. Hence, the nature of the histories by means of which telephone communication has been established with the party becomes clear at a glance.

The portable terminal apparatus of the present invention also has a configuration of the display unit displays the history of outgoing calls and the history of incoming calls so as to add indications to the respective histories to enable discrimination between the history of outgoing calls and the history of incoming calls.

By the above configuration, the user can clearly understand, at a glance, the nature of the histories by means of which outgoing phone calls and incoming phone calls have been made with respect to the single party. The user can jog his or her memory by means of taking the histories as clues.

The portable terminal apparatus of the present invention has a structure that the history includes dates of outgoing and incoming calls and duration of each of the calls.

By the above configuration, dates of outgoing and incoming calls and the duration of each of the phone calls can be ascertained in time series.

A portable terminal apparatus of the present invention comprises a storage unit that stores a transmitted electronic mail and a received electronic mail; a detection unit that detects an electronic mail related to the other party designated by the designation unit; a control section into which a name of the other part is input; a telephone directory section configured to store the name of the other party and at least one of an electronic mail address of the other party and photographic data related to the other party associated with the name of the other party; and a display unit that displays at least one of the name of the other party and the photographic data related to the other party, and a content of the electronic mails in the electronic mails related to the other party detected by the detection unit during the transmitted electronic mail and the received electronic mail are mixed and sorted in time sequence.

By the above configuration, the transmitted electronic mails and the received electronic mails, which pertain to the designated party, can be displayed while being mixed in list form and in time series. Hence, the manner in which the electronic mails have been exchanged with the designated party is clearly seen at a glance.

The portable terminal apparatus of the present invention also has a configuration that the display unit displays the electronic mails exchanged with the other party so as to add indications which discriminate the received electronic mail from the transmitted electronic mail.

By the above configuration, the manner in which the electronic mails have been exchanged with the single party is dearly seen at a glance. The user can jog his or her memory.

A portable terminal apparatus of the present invention comprises a storage unit that stores a transmitted electronic mail and a received electronic mail; a detection unit that detects an electronic mail related to the other party designated by the designation unit; a telephone directory section configured to store the name of the other party and an electronic mail address of the other party so as to associate with each other; and a display unit that displays a designated electronic mail by designating an arbitrary electronic mail while portions of opening sentences of the electronic mails exchanged with the other party detected by the detection unit are displayed so that the transmitted electronic mail and the received electronic mail which are exchanged with the other party, are displayed while being mixed in time sequence and while the electronic mails exchanged with the other party are displayed in list form.

By the above configuration, the electronic mails transmitted to and those received from the designated party can be displayed while being mixed in time series and in list form. Accordingly, the manner in which the electronic mails have been exchanged with the designated party is clearly seen at a glance.

The portable terminal apparatus of the present invention has such a configuration that the display unit retrieves a desired party by use of all or portions of the name or the electronic mail address stored in the telephone directory section, and selects the name of the retrieved party.

By the above configuration, a desired party is retrieved by use of all or portions of the registered names and the registered electronic mail addresses, whereby the retrieved party can be designated.

The present invention can provide a portable terminal apparatus which can readily and accurately display in time sequence exchanges of electronic mails and phone calls.

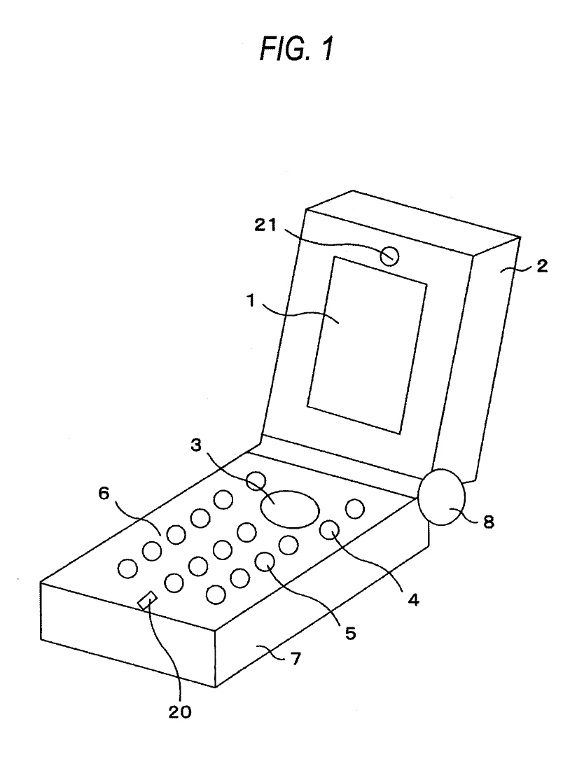

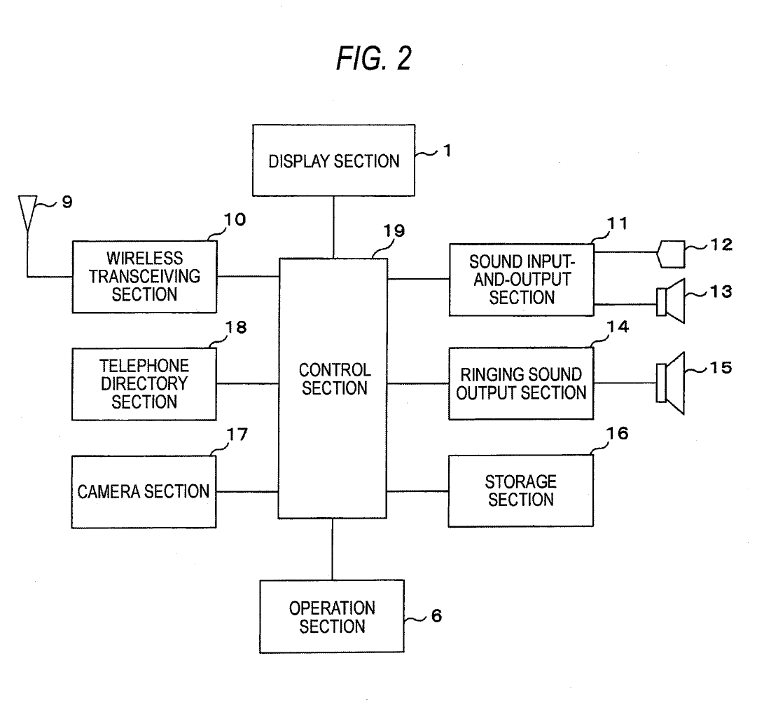

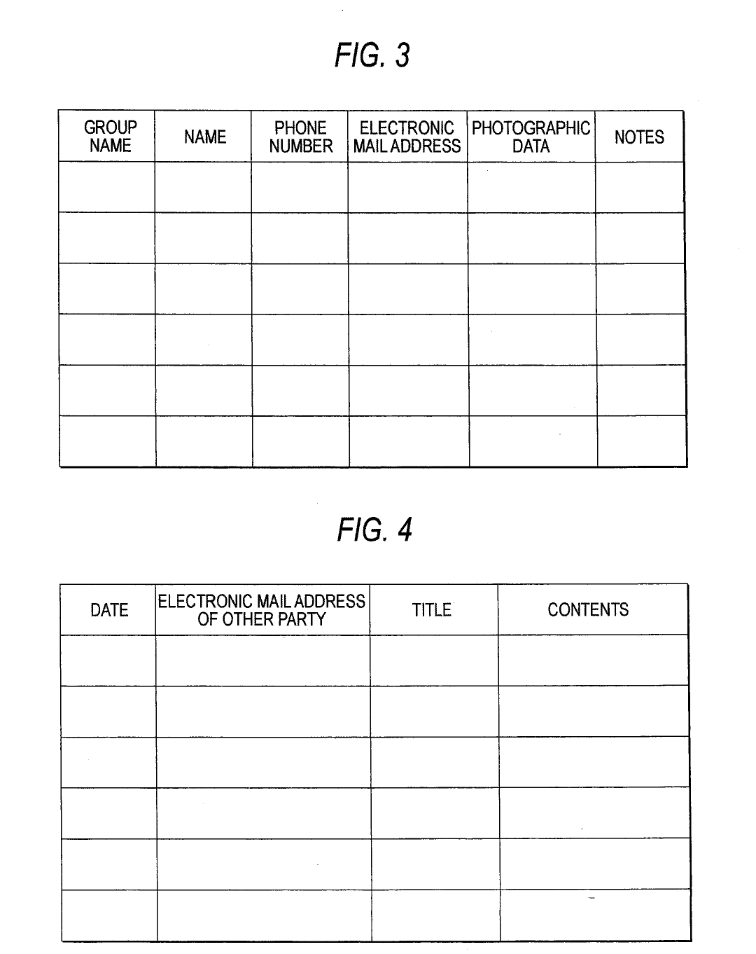

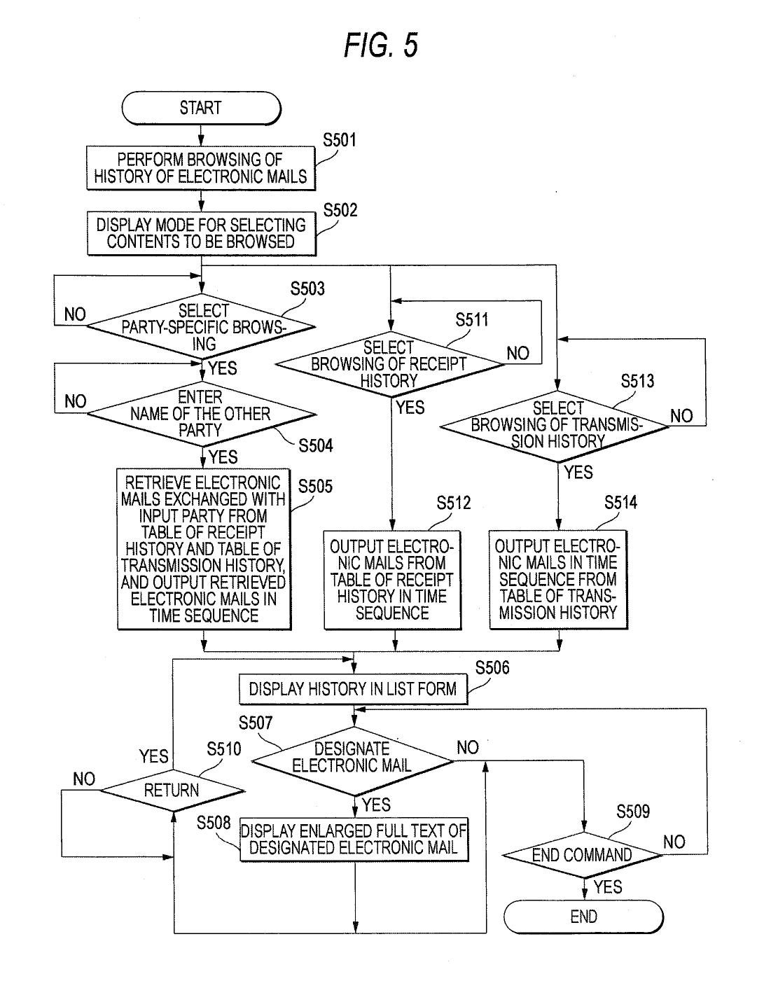

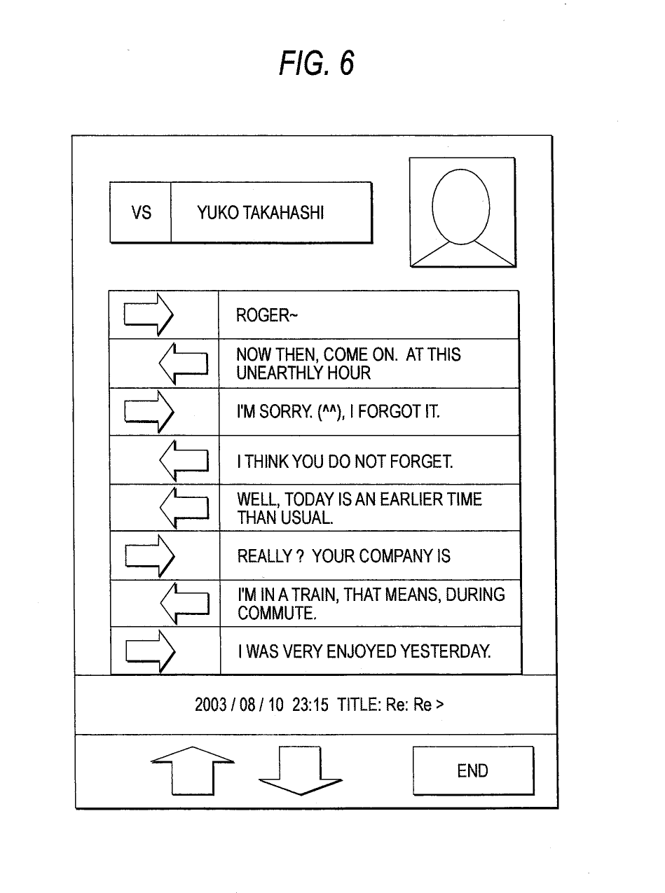

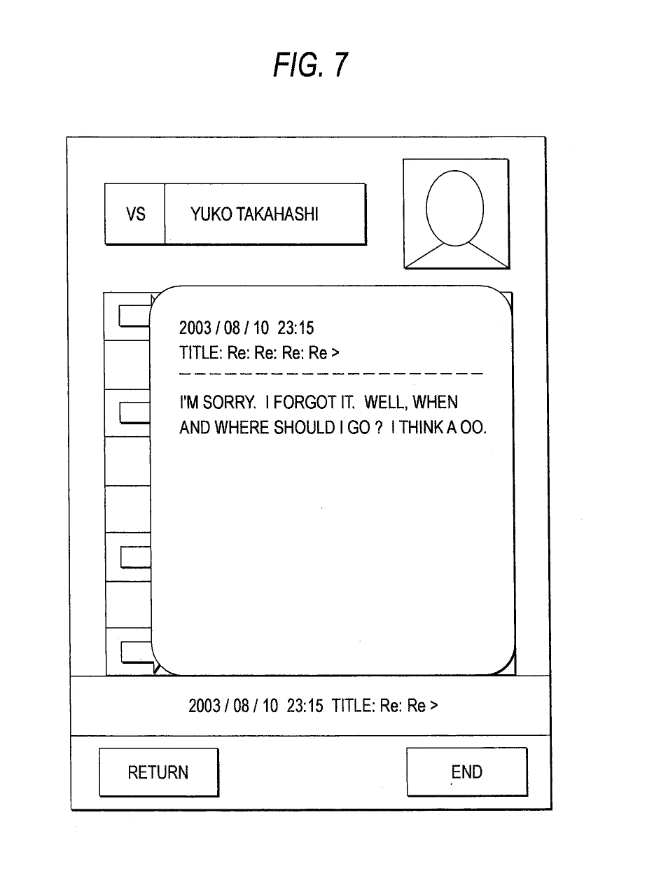

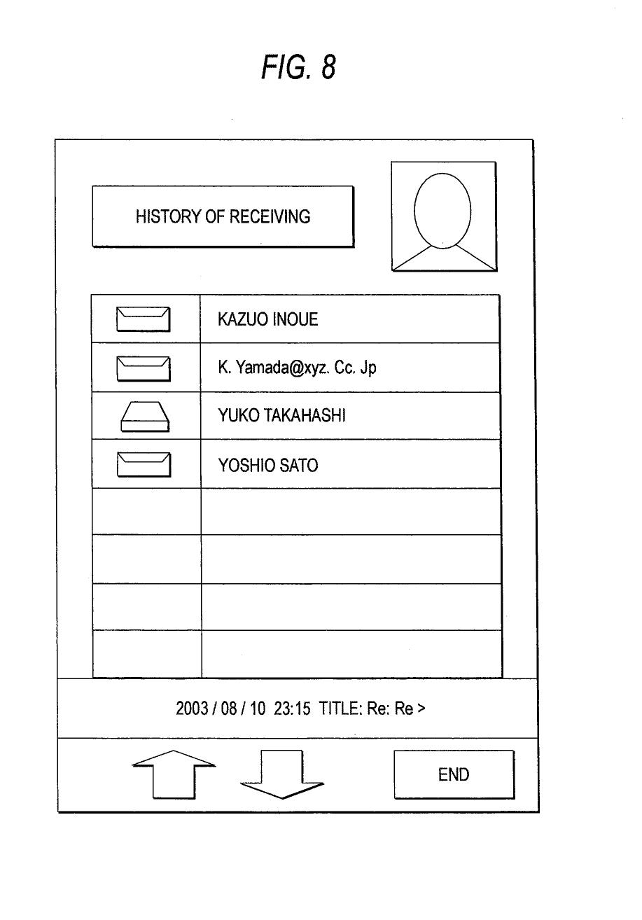

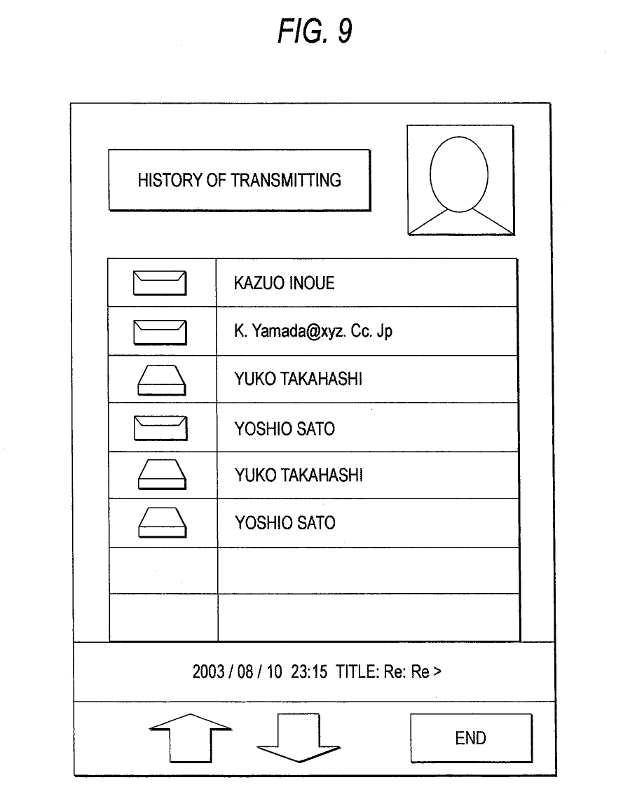

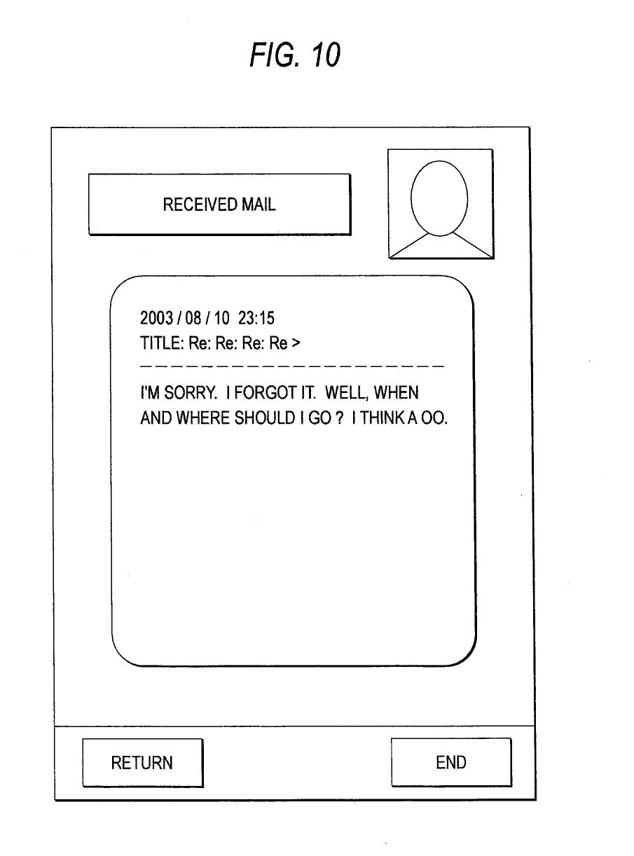

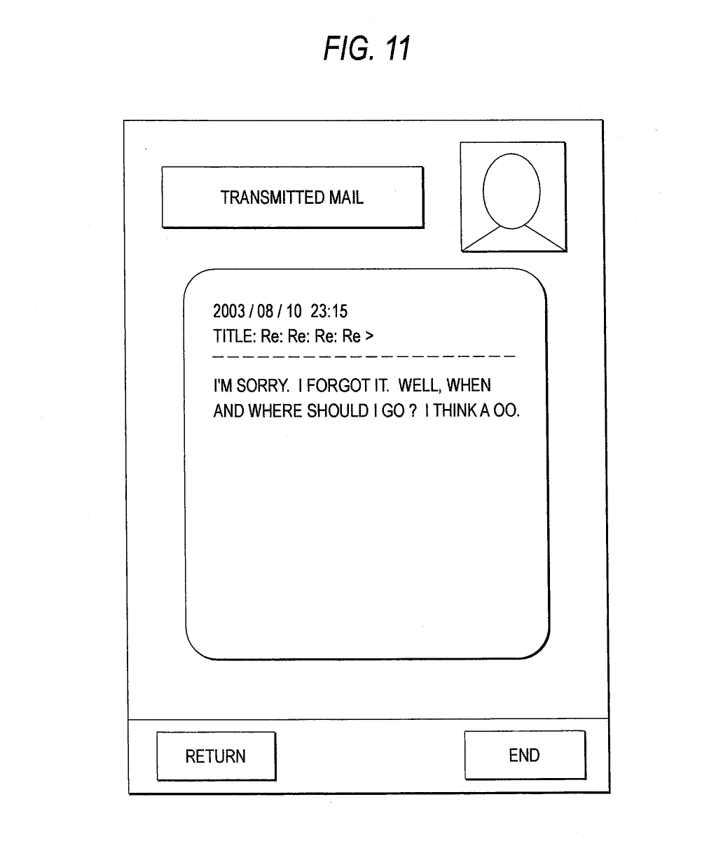

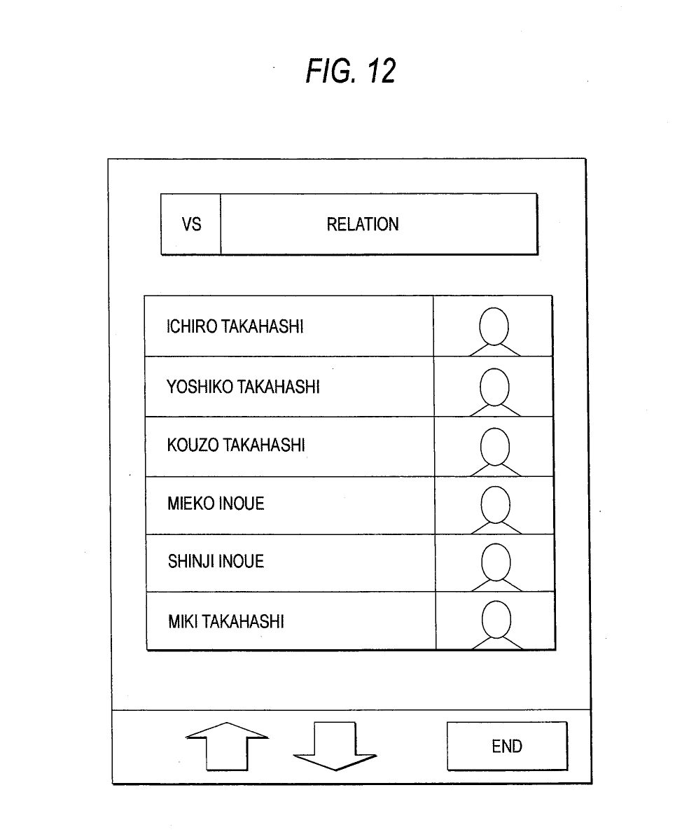

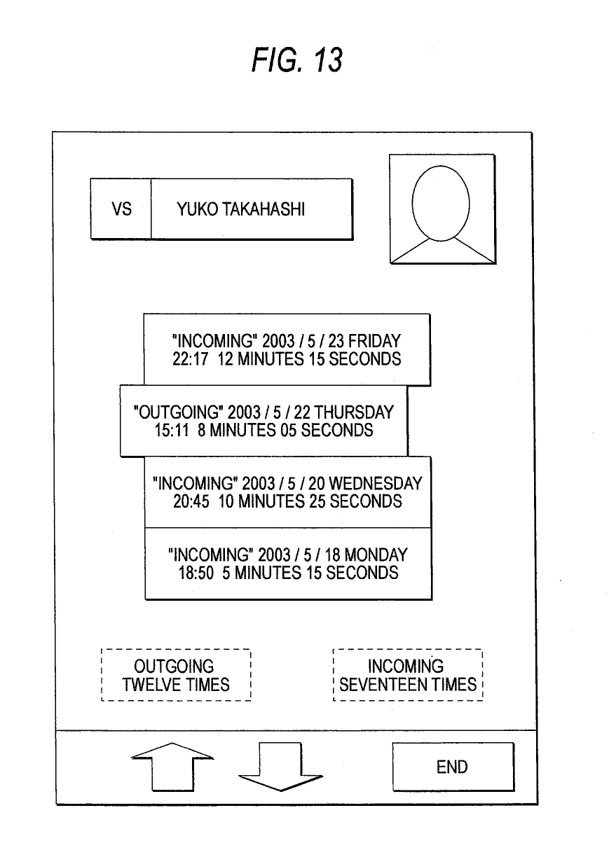

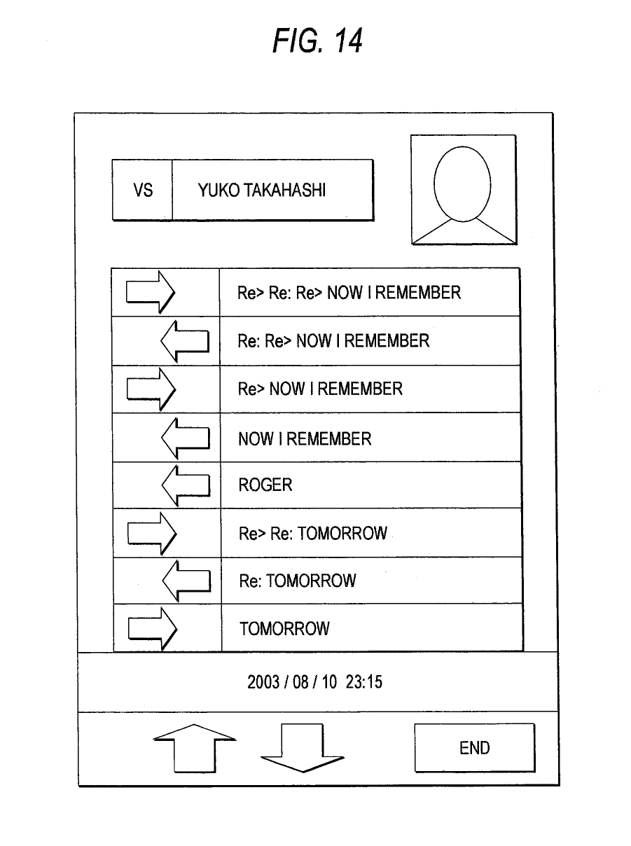

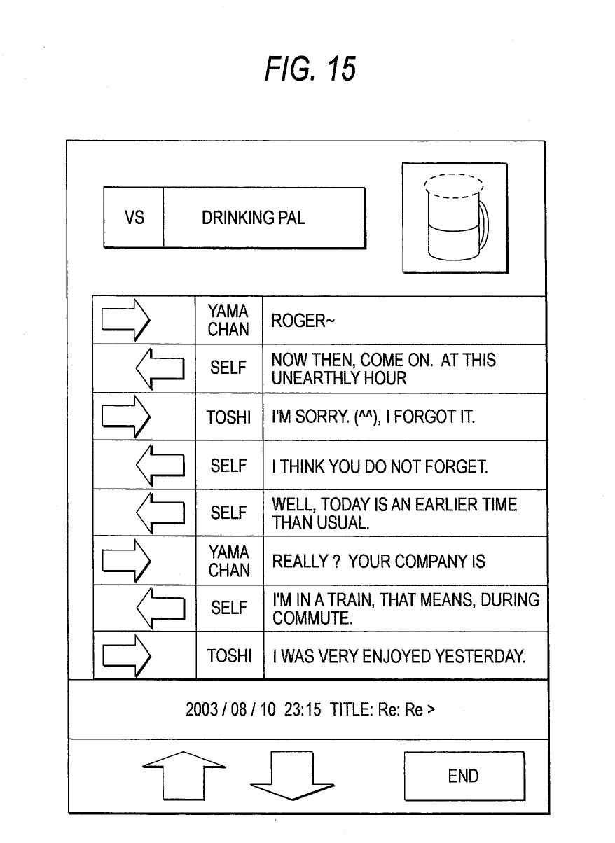

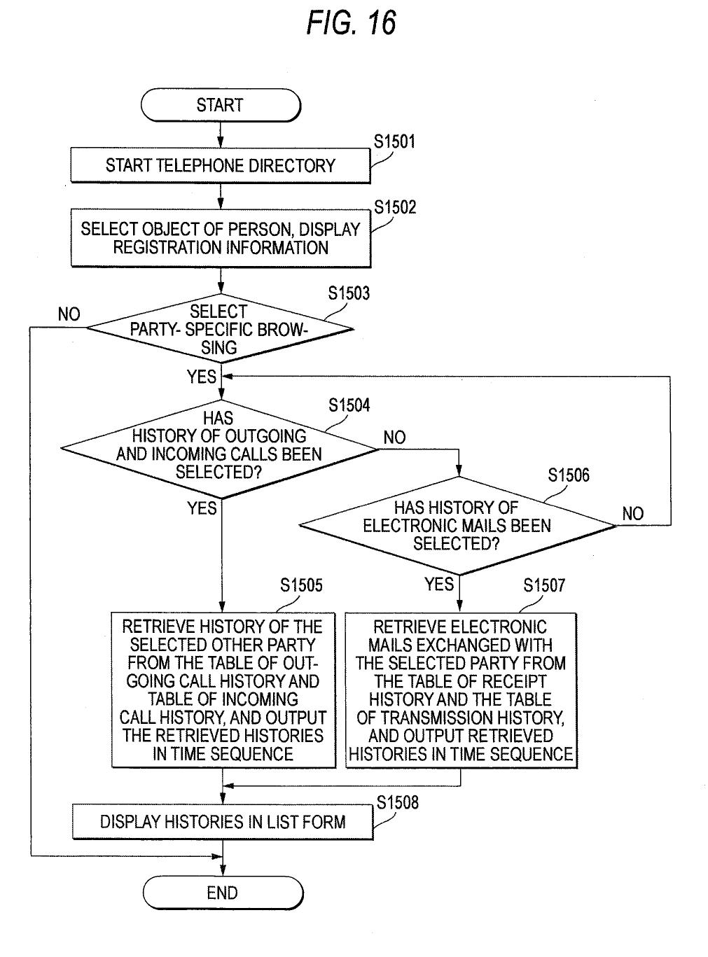

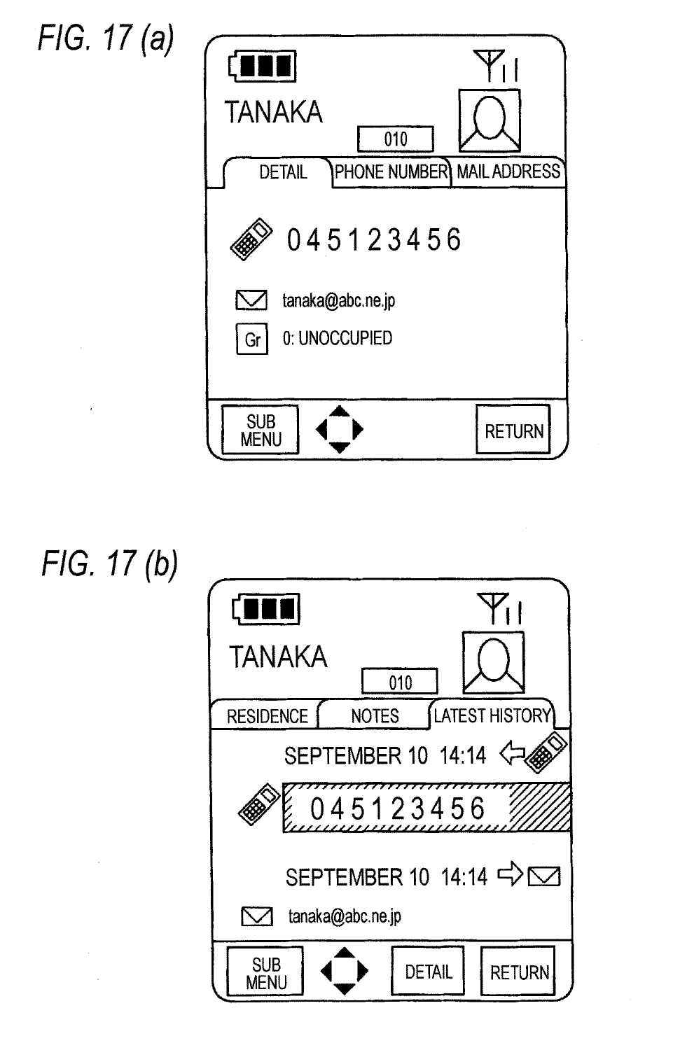

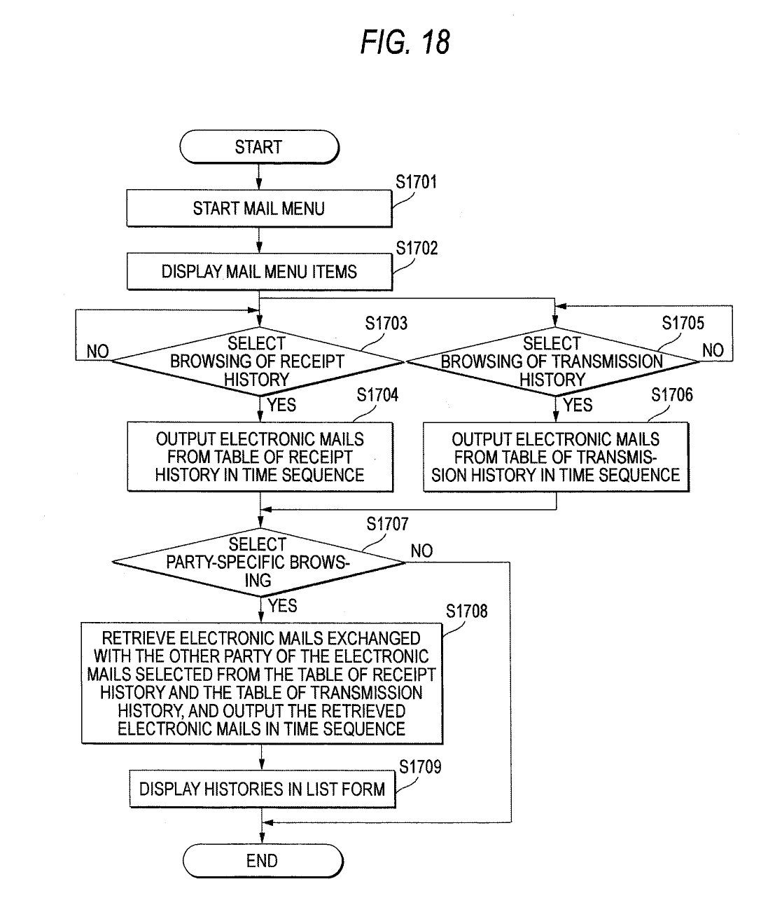

### BRIEF DESCRIPTION OF THE DRAWINGS

[FIG. 1] is an external view of a portable terminal apparatus according to an embodiment of the present invention;

[FIG. 2] is a diagrammatic block diagram of the portable terminal apparatus according to the embodiment of the present invention;

[FIG. 3] is a view showing the configuration of a telephone directory section used in the portable terminal apparatus according to the embodiment of the present invention;

[FIG. 4] shows the configuration of a storage section used in the portable terminal apparatus according to the embodiment of the present invention;

[FIG. 5] is a flowchart showing operation of the portable terminal apparatus according to the embodiment of the present invention;

[FIG. 6] is a view showing a display on the portable terminal apparatus according to the embodiment of the present invention appearing when party-specific browsing has been selected;

[FIG. 7] is a view showing a display on the portable terminal apparatus according to the embodiment of the present invention appearing when the full text of a designated electronic mail has been displayed on the portable terminal apparatus;

[FIG. 8] is a view showing a display on the portable terminal apparatus according to the embodiment of the present invention acquired when receipt history browsing has been selected;

[FIG. 9] is a view showing a display on the portable terminal apparatus according to the embodiment of the present invention appearing when transmission history browsing has been selected;

[FIG. 10] is a view showing an example display on the portable terminal apparatus according to the embodiment of the present invention appearing when transmission history browsing is selected and, in addition, a command for displaying a full text of the designated electronic mail has been issued;

[FIG. 11] is a view showing an example display on the portable terminal apparatus according to the embodiment of the present invention appearing when transmission history browsing is selected and, in addition, a command for displaying a full text of the designated electronic mail has been issued;

[FIG. 12] is a view showing an example display on the portable terminal apparatus according to one method appearing when the name of the other party has been input in the cellular phone according to the embodiment of the present invention;

[FIG. 13] is a view showing an example display on the portable terminal apparatus according to the embodiment of the present invention appearing when a command for displaying the party-specific history of telephone calls has been issued;

[FIG. 14] is a view showing another example display on the portable terminal apparatus according to the embodiment of the present invention appearing when party-specific browsing has been selected;

[FIG. 15] is a view showing another example display on the portable terminal 5 apparatus according to the embodiment of the present invention appearing when party-specific browsing has been selected with a designated group;

[FIG. 16] is a flowchart showing a second example method for designating the other party during party-specific browsing in the embodiment of the present invention;

[FIG. 17] is a view showing an example display of telephone directory 10 registration information according to the embodiment of the present invention; and

[FIG. 18] is a flowchart showing a third example method for specifying the other party during party-specific browsing in the embodiment of the present invention.

### BEST MODE FOR IMPLEMENTING THE PRESENT INVENTION

The best mode for implementing the present invention will be described hereinbelow.

FIG. 1 is an external view of a portable terminal apparatus according to an embodiment of the present invention, and FIG. 2 is a diagrammatic block diagram of the portable terminal apparatus.

As shown in FIGS. 1 and 2, the portable terminal apparatus of the embodiment of the present invention comprises a first housing 2 having a display section 1; and a second housing 7 having an operation section 6 formed from various operation keys such as a navigation key 3, a function key 4, a ten key pad 5, and the like. The housings 2, 7 are joined together, at respective single ends, by means of a hinge section 8, and can be opened or closed around the hinge section 8.

As shown in FIG. 2, in addition to incorporating the display section 1 and the operation section 6, the housings 2, 7 incorporate a wireless transceiving section 10 connected to an antenna 9, a sound input-and-output section 11, a microphone 12 connected to the sound input-and-output section 11, a receiver 13, a ringing sound output section 14, a speaker 15 for outputting a ringing sound connected to the ringing sound output section 14, a storage section 16 for storing received electronic mails and transmitted electronic mails, a camera section 17, a telephone directory section 18, and a control section 19 for controlling these respective sections.

The microphone 12 is provided at a position opposing a through hole 20 for collecting sound which is formed in the second housing 7, and the receiver 13 is provided at a position opposing a through hole 21 for emitting a sound formed in the first housing 2. Although not illustrated, the speaker 15 is provided at a position opposing a through hole for emitting a sound formed on the back of the first or second housing. Although not illustrated, a camera constituting the camera section 17 is provided so that a lens section can become exposed in the back of the first housing 2.

Operation of the portable terminal apparatus of the embodiment of the present invention will now be described in detail.

First, in the portable terminal apparatus according to the embodiment of the present invention, the first and second housings 2, 7 are formed so as to be able to open or close by means of the hinge section 8. By means of performing a predetermined operation through use of the operation section 6 with the first and second housings 2, 7 opened, transmission and receipt of an electronic mail or origination or receipt of a phone call can be performed, as required.

Specifically, when a phone call is originated, a phone number of the other party is input by use of the ten-key pad 5 or a predetermined operation key is operated to thus withdraw a phone number of the other party from the telephone directory section 18. The phone number is temporarily displayed on the display section 1, and a predetermined key to be used for originating a call is actuated in that state. Thereby, the phone number input by way of the ten-key pad 5 or the phone number called up from the telephone directory section 18 can be transmitted to an unillustrated telephone cell site by way of the transceiving section 10, to thus originate a phone call.

When the other party has answered the originated phone call, a communication circuit is automatically established between the called party and the calling party. Accordingly, the two parties can communicate with each other by way of the sound input-and-output section 11 and the wireless transceiving section 10 by use of the microphone 12 and the speaker 13.

When a phone call has been sent from the other party and the phone call is received by the transceiving section 10, a predetermined calling signal is output from the speaker 15 under control of the control section 19, by means of the ringing sound output section 14, whereby a predetermined ringing sound is output from the speaker. Consequently, the user can communication with the other party by means of performing the predetermined key that has been determined beforehand in preparation for the ringing sound.

Likewise, even when an electronic mail is transmitted, an electronic mail is first prepared by use of the navigation key 3, the function key 4, and the ten-key pad 5. Further, an electronic mail address of the other party is called up from the telephone directory section 18 or input by use of the ten-key pad 5. The electronic mail address is temporarily displayed on the display section 1, and a predetermined key for transmission purpose is operated in this state. Thus, the electronic mail prepared by use of the navigation key 3, the function key 4, and the ten-key pad 5 is transmitted to an electronic mail provider (not shown) by way of the wireless transceiving section 10, along with the electronic mail address input by way of the ten-key pad 5 or the electronic mail address called up from the telephone directory section 18, so that the electronic mail can be transmitted to the other party.

The wireless transceiving section 10 automatically receives an electronic mail from the other party, and the thus-received electronic mail is automatically stored in the storage section 16 under control of the control section 19. Consequently, the electronic mail is called up from the storage section 16 by use of the operation section 6, whereby the mail can be readily ascertained while being displayed on the display section 1.

Incidentally, in the portable terminal apparatus of the present embodiment, as shown in FIG. 3, the telephone directory section 18 is configured to be able to store a group name, an electronic mail address, photographic data such as a photograph of a face, and a note, all pertaining to the other party, while being associated with the name of the other party, in addition to storing the name and phone number of the other party.

When a name, a phone number, a group name, an electronic mail address, photographic data, and a note, all pertaining to the other party, are stored in the telephone directory section 18, the portable terminal apparatus is switched to a telephone directory mode by use of the operation section 6, and these items can be arbitrarily stored in that state by use of arbitrary keys of the operation section 6. Namely, in the present embodiment, all these pieces of data can be manually input by use of the operation section 6. Further, the configuration is also made such that required data among pieces of received data can be arbitrarily stored in the telephone directory section 18 by use of data pertaining to an outgoing call or transmitted data and data transmitted from the other party at the time of receipt of an incoming call or received data. In relation to photographic data, such as a photograph of the other party's face, the configuration is made such that a photograph of the other party's face captured by the camera section 17, a photograph of the face of the other party transmitted as an attached file from the other party along with the electronic mail, and the like can be stored in a predetermined area while being associated with the name of the other party.

The storage section 16 has a transmission history table and a receipt history table. As shown in FIG. 4, all pieces of data, such as a date when electronic mails were exchanged with the other party, an electronic mail address of the other party, the title of the electronic mail, and contents of the electronic mail can be stored in each of these tables. When electronic mails have been exchanged with the other party, the pieces of data are automatically stored as a history under control of the control section 19. Although not illustrated, the storage section 16 also has a phone history table for storing an outgoing call date when a phone call was originated, the duration of an outgoing call, an incoming call date when a phone call was received, and the duration of an incoming call. When a phone call is originated or a phone call is received, these pieces of data are also automatically stored under control of the control section 19.

First, in the portable terminal apparatus of the present embodiment, operation for displaying the history of electronic mails or the history of phone calls will be described in detail by reference to FIGS. 5 through 12.

First, as shown in FIG. 5, when the history of electronic mails is displayed, predetermined operation for browsing the history of electronic mails is performed by use of the operation section 6 (S501). When operation for browsing the history of electronic mails has been performed, information about the operation is input to the control section 19, and the portable terminal apparatus is brought into an electronic mail history browsing mode under control of the control section 19. In this state, the portable terminal apparatus enters a mode where contents to be browsed are selected (S502). The thus-selected contents are displayed on the display section 1.

Party-specific browsing of electronic mails, browsing of a receipt history, and browsing of a transmission history are provided as items on the display section 1, and a display for prompting selection of any one from the display is provided.

On the assumption that the party-specific browsing has now been selected by use of the operation section 6 according to the display on the display section 1 (Y in S503), a display for prompting input of a name of the party to be browsed is provided. When the name of the party to be browsed has been input by use of the operation section 6 (Y in S504), the input is sent to the control section 19. Under control of the control section 19, only the electronic mails pertaining to the input party are detected from the transmission history table and the receipt history table in the storage section 16 (S505). The thus-detected electronic mails are displayed in list form and in time series on the display section 1 without regard to whether the mails were transmitted or received (S506).

Specifically, as shown in FIG. 6, in this case, so long as the name of the input party and the photograph of the same are stored in the telephone directory section 18, the photograph of the party is read under control of the control section 19. The photograph is displayed on the display section 1. In addition to the name and the photograph, the electronic mails exchanged with the party are displayed in time sequence on the display section 1 along with, e.g., a right arrow showing received mails and a left arrow showing transmitted mails. Further, the opening sentences of the thus-displayed electronic mails are displayed as far as possible on the display section 1.

As shown in FIG. 14, it may be the case that only the titles of the electronic mails are displayed as a list of electronic mails exchanged with the designated party. Thus, as a result of display of only the briefly-described titles, the nature of transmitted and received electronic mails can be readily grasped.

It may also be the case that the title of each of the transmitted and received electronic mails and all or a portion of the full text of the electronic mail are displayed. Even when a photograph of the designated party is stored in the telephone directory section 18, display of a photograph in the display of party-specific browsing may be omitted.

When one of the displayed electronic mails is designated in this state by use of the operation section 6 and operation for desiring a display of the full text is performed (Y in S507), the full text of the designated electronic mail is displayed in an enlarged manner so as to essentially fill the screen of the display section 1 with the full text, as shown in FIG. 7 (S508).

When completion operation is performed (Y in S509) without designating any one from the displayed electronic mails (N in S507), the electronic mail browsing display mode is completed at that point in time. When the completion operation is not performed (N in S509), processing returns to a mode (S507) for designating one from the displayed electronic mails, and that status is maintained.

When “return” operation is performed (S510) with the designated electronic mail being fully displayed (S508), the display of the full text is completed, and processing returns to a history browsing display shown in FIG. 6 (S506).

When browsing of a receipt history is selected (S511) in the mode for selecting contents to be browsed (S502), electronic mails are output from only the receipt history table in the storage section 16 (S512). The thus-output electronic mails are displayed in list form on the display section 1 (S506) Specifically, in this case, as shown in FIG. 8, the opened status of electronic mails which have been received thus far (e.g., indicated by an opened or closed state of an illustration of an envelope), the names of the parties with which the electronic mails were exchanged, and mail addresses of the parties are displayed as a receipt history in list form. When one has been selected from the displayed electronic mails by use of the operation section 6, the received date of the thus-selected electronic mail is displayed in a portion of the display section 6 (e.g., a specific area provided in a lower portion of the display of the list) Moreover, when the photograph of the party of the thus-selected one electronic mail is registered in the telephone directory section 18, the photograph of the party is read from the telephone directory section 18 under control of the control section 19, and the thus-read photograph is displayed in a portion of the display section 6 (e.g., a specific area in an upper right position on the display section).

When browsing of the transmission history is selected (S513) in the mode for selecting contents to be browsed (S502), electronic mails are output from only the transmission history table of the storage section 16 (S514). The thus-read electronic mails are displayed in the display section 1 in list form (S506). Specifically, in this case, as shown in FIG. 9, the transmitted status of electronic mails which have been transmitted thus far (e.g., transmitted electronic mails are indicated with an illustration of an opened envelope, and untransmitted electronic mails are indicated with an illustration of a closed envelope), the names of the parties with which the electronic mails were exchanged, and mail addresses of the parties are displayed as a transmission history in list form. When one has been selected from the displayed electronic mails by use of the operation section 6, the transmitted date or prepared date of the selected electronic mail is displayed in a portion of the display section 6 (e.g., a specific area provided in the lower portion of the list display). Moreover, when the photograph of the party of the selected one electronic mail is registered in the telephone directory section 18, the photograph of the party is read by the telephone directory section 18 under control of the control section 19. The thus-read photograph is displayed in a portion of the display section 6 (e.g., a specific area at an upper right location on the display section).

Even when any one has been selected from the receipt history and the transmission history, one electronic mail is designated from among the history provided in list form. When operation for displaying the full text of the designated electronic mail has been performed (Y in S507), the full text of the designated electronic mail is displayed as shown in FIGS. 10 and 11 (S508).

When party-specific browsing has been selected (Y in S503) in the mode for selecting contents to be browsed (S502) and when the name of the party is input (S504), the name of the party is directly input by use of the operation section 6 in the present embodiment. As mentioned previously, group names, names, phone numbers, and electronic mail addresses are stored in the telephone directory section 18. As shown in FIG. 12, a group name may be first designated by use of the group names, and the other party may be selected from the group or input. Alternatively, a desired party may be retrieved by use of all or portions of the registered names, phone numbers, and electronic mail addresses, the thus-retrieved party may be designated, and the name of the party may be input

The party to be designated through party-specific browsing may include a group stored in the telephone directory section 18 or a specific individual. Specifically, a specific group may be designated, and electronic mails exchanged with the parties registered in the group may be displayed in list form.

FIG. 15 is a view showing a case where party-specific browsing of the designated group is selected in the portable terminal apparatus according to the embodiment of the present invention. As shown in FIG. 15, when a “drinking buddies” group has been designated as the other party for the party-specific browsing of the electronic mails, the group name, an icon representing the group, and exchange of electronic mails with the parties registered as members of the “drinking buddies” group in the telephone directory section 18, and the like, are displayed. The group can be arbitrarily registered as, e.g., “schoolmates,” “company,” “Club activity,” and the like, by the user of the portable terminal apparatus.

When photographs of faces of the members are registered in the telephone directory section 18, the photographs may be displayed beside the names of the members or in lieu of the names. Further, it may be the case that only the photograph of the face of the party whose electronic mail is currently selected is displayed in a portion of the screen.

Browsing operation has been described above in connection with the case where the history of electronic mails is browsed. However, the present embodiment is configured so that the history of phone calls can also be browsed in the same manner. Specifically, when operation for browsing the history of phone calls is performed by use of the operation section 6, the portable terminal apparatus enters a mode for selecting contents to be browsed from the history of phone calls as in the case of the electronic mails. A display for prompting selection of any one from party-specific browsing, browsing of incoming call history, and browsing of outgoing call history is provided on the display section 1. When party-specific browsing is selected according to the display on the display section 1, the portable terminal apparatus enters a mode for inputting the name of the party. When the name of the party is input in this mode, the history of outgoing calls and the history of incoming calls in connection with the party are displayed while being mixed in time sequence in the display section 1, as shown in FIG. 13. Specifically, in this case, in addition to distinction between outgoing calls and incoming calls, dates when the outgoing and incoming calls were made, and duration of phone calls, the number of times outgoing calls or incoming calls were made are also simultaneously displayed on the display section 1.

In a case where browsing of the history of incoming calls and browsing of the history of outgoing calls have been selected, although not illustrated, only the history of incoming calls or the history of outgoing calls is displayed in time sequence as shown in FIG. 13.

Incidentally, in the embodiment shown in FIG. 5, the party who is an object of the display of party-specific browsing is designated from the history of electronic mails by means of inputting the name of the party. However, various methods, including methods which will be described below, can be applied to the method for designating the other party in relation to a display of party-specific browsing. FIG. 16 is a flowchart showing a second example method for designating the other party in relation to party-specific browsing in the embodiment of the present invention.

As shown in FIG. 16, when the user has input a command for starting a telephone directory by way of the operation section 6, the control section 19 calls up registration information, including at least one of a name, a phone number, an electronic mail address, a photograph, a postal address, a note, and the like, stored in the telephone directory section 18 in accordance with a command for starting the telephone directory from the operation section 6 (step S1501).

When retrieval and selection of a registered person from the registration information displayed in the display section 1 are performed by use of the operation section 6, the control section 19 displays on the display section 1 display information, such as registration information and history information, about the selected person, and the like (step S1502).

FIG. 17(a) is a view showing an example display of registration information. As shown in FIG. 17(a), the display information includes tags showing items, such as a registered name, a registered photograph, a phone number of a registered person, an electronic mail address of the same, and the like. By means of the selected item, operation associated with the item, e.g., origination of an outgoing phone call, preparation of an electronic mail, and the like, can be performed.

Subsequently, when party-specific browsing is effected in relation to the displayed person (Y in step S1503), the history of outgoing and incoming calls (step Si 504) or the history of electronic mails (step SI 505) can be selected.

As shown in FIG. 17(b), in the embodiment shown in Fig. 17, a tag of the latest history item in the display information is selected, to thus designate a phone number or an electronic mail address of the item, As a result, party-specific browsing and an object thereof (the history of outgoing and incoming calls or the history of electronic mails) can be selected. When a plurality of phone numbers or electronic mail addresses are registered in relation to a single person, each of the registered phone numbers or each of the electronic mail addresses may be designated, to thus display corresponding history of outgoing and incoming phone calls or corresponding history of electronic mails.

When party-specific browsing of the history of outgoing and incoming calls has been selected (Y in step S1504), the control section 19 retrieves and reads the history of the designated party from the table of the history of phone calls stored in the storage section 16, and the thus-read history of outgoing and incoming phone calls is output in time sequence to the display section 1 (step S1505).

When party-specific browsing of the history of electronic mails is selected (Y in step S1506), the control section 19 retrieves and reads electronic mails pertaining to the selected party from the table of the history of received electronic mails and the table of the history of transmitted electronic mails, which are stored in the storage section 16, and the history of electronic mails read on the display section 1 is output in time sequence (step S1507).

The display section 1 displays the history of outgoing and incoming phone calls or the history of electronic mails output from the control section 19, in list form (step S1508). An example display of the history of outgoing and incoming phone calls is provided in FIG. 13, and an example display of the history of electronic mails is provided in FIG. 6 or 14. Operation performed after the history of electronic mails has been displayed in list form is the same as that subsequent to step S507 shown in FIG. 5.

As mentioned above, the other party is selected from the telephone directory section, and the other party is browsed in accordance with the display information. Accordingly, an object of display and browsing of the other party can be readily selected.

FIG. 18 is a flowchart showing a third example method for designating the other party of party-specific browsing in the embodiment of the present invention. As shown in FIG. 18, the user first starts a mail menu by use of the operation section 6 (step S1701). The control section 19 displays mail menu items in accordance with a command for starting a mail menu from the operation section 6 (step S1702).

The mail menu items include browsing of received electronic mails, browsing of transmitted electronic mails, preparation of a new electronic mail, various settings, and the like. When the menu items are designated by the user by way of the operation section 6, the display section 1 provides a display related to the selected menu item; for instance a mail preparation screen in the case of preparation of a new electronic mail, or a display of various setting menu screens, or the like, in the case of the settings.

When browsing of the history of received electronic mails has been selected from the menu items (Y in step S1703), the control section 19 reads received electronic mails, which are electronic mails stored in the receipt table of the storage section 16, and outputs the thus-read received electronic mails to the display section 1 in time sequence (step S1704).

When browsing of the history of transmitted electronic mails has been selected from the menu items (Y in step S1705), the control section 19 reads the received electronic mails, which are the electronic mails stored in the receipt table of the storage section 16, and outputs the thus-read received electronic mails to the display section 1 (step S1704).

The received electronic mails or transmitted electronic mails, which have been output in step S1704 or S1706, are displayed in time sequence and in list form in the display section 1. When the user has selected a party-specific browsing menu for the party with which a desired electronic mail was exchanged, with the desired electronic mail being selected (Y in step S1707), the control section 6 retrieves and reads electronic mails exchanged with the same party as that with which the selected electronic mail was exchanged, from the table of the history of received electronic mails and the table of the history of transmitted electronic mails, which are stored in the storage section 16. The history of the thus-read electronic mails is output to the 25 display section 1 in time sequence (step S1708).

The display section 1 displays in list form the history of outgoing and incoming phone calls or the history of electronic mails output from the control section 19 (step S1709). An example display of the history of outgoing and incoming phone calls is shown in FIG. 13, and an example display of the history of electronic mails is shown in FIG. 6 or 14. Operation performed after the history of electronic mails has been displayed in list form is identical with that subsequent to step S507 shown in FIG. 5.

As mentioned above, the other party is selected from the history of transmitted and received electronic mails, and the other party is browsed in accordance with the display information. Accordingly, an object of party-specific browsing and display can be readily selected.

As above, according to the present embodiment, so long as party-specific browsing has been selected, the transmitted electronic mails, the received electronic mails, the outgoing phone calls, and the incoming phone calls can be displayed in time sequence without regard to their nature. The manner in which the electronic mails were exchanged with the designated party and contents of the electronic mails can be clearly displayed. Even in the case of telephone calls, there can be yielded an advantage of capability of displaying the history of phone calls in list form without regard to whether the phone calls are incoming calls or outgoing calls.

The above description has mentioned the case where the titles and texts of the transmitted and received electronic mails and incoming and outgoing phone calls are displayed in list form by means of designating the other party or a group. However, a time range may be designated, and titles and texts of electronic mails exchanged within the time range, and incoming calls and outgoing calls provided within time range may be displayed in list form. The time range may be designated by a certain date and month, as well as by a time such as “3 pm of August 10 to 8 pm of August 11”, or the like. Moreover, a third party or group may be designated in combination with the time range.

Although the present invention has been described in detail by reference to the specific embodiment, it is manifest to those skilled in the art that the present invention is liable to various alterations or modifications without departing from the spirit and scope of the present invention.

The present patent application claims priority to Japanese Patent Application (JP-A-2003-370051) filed on Oct. 30, 2003; Japanese Patent Application (JP-A-2004-294895) filed on Oct. 7, 2004; Japanese Patent Application (JP-A-2004-294902) filed on Oct. 7, 2004; and Japanese Patent Application (JP-A-2004-314695) filed on Oct. 28, 2004, which are incorporated herein by reference in their entireties.

### INDUSTRIAL APPLICABILITY

The portable terminal apparatus of the present invention yields an advantage of the capability of readily, accurately displaying exchange of electronic mails and phone calls in time sequence, and is useful for a cellular phone or the like.

1. A portable terminal apparatus, comprising:
a storage unit that stores a transmitted electronic mail and a received electronic mail;
a telephone directory storage unit that stores registration information including at least one of a name, a phone number, and a mail address;
a designation unit that designates a party on the other end from the stored registration information;
a detection unit that reads and detects, from the storage unit, an electronic mail related to the other party designated by the designation unit; and
a display unit that displays the electronic mails related to the other party detected by the detection unit so that the transmitted electronic mail and the received electronic mail are displayed while being mixed in list form and in time sequence.

2. A portable terminal apparatus, comprising:
a storage unit that stores a transmitted electronic mail and a received electronic mail;
a designation unit that designates a desired electronic mail from the stored electronic mail;
a detection unit that reads and detects, from the storage unit, an electronic mail exchanged with the other party that is the same party with whom the electronic mail designated by the designation unit is exchanged; and
a display unit that displays the electronic mails detected by the detection unit so that the transmitted electronic mail and the received electronic mail are displayed while being mixed in time series and in list from.

3. The portable terminal apparatus according to claim 1, wherein the display unit displays titles of the electronic mails in list form as the list form display.

4. A portable terminal apparatus, comprising:
a storage unit that stores a history of outgoing calls and a history of incoming calls;
a detection unit that detects the history of outgoing calls and the history of incoming calls with regard to a party designated by designation unit from the histories of outgoing calls and the histories of incoming calls stored in the storage unit; and
a display unit that displays the history of outgoing calls and the history of incoming calls while being mixed detected by the detection unit in time series and in list form.

5. The portable terminal apparatus according to claim 4, wherein the display unit displays the history of outgoing calls and the history of incoming calls so as to add indications to the respective histories to enable discrimination between the history of outgoing calls and the history of incoming calls.

6. The portable terminal apparatus according to claim 4, wherein the history includes dates of outgoing and incoming calls and duration of each of the calls.

7. A portable terminal apparatus, comprising:
a storage unit that stores a transmitted electronic mail and a received electronic mail;
a detection unit that detects an electronic mail related to the other party designated by the designation unit; a control section into which a name of the other part is input;
a telephone directory section configured to store the name of the other party and at least one of an electronic mail address of the other party and photographic data related to the other party associated with the name of the other party; and
a display unit that displays at least one of the name of the other party and the photographic data related to the other party, and a content of the electronic mails in the electronic mails related to the other party detected by the detection unit during the transmitted electronic mail and the received electronic mail are mixed and sorted in time sequence.

8. The portable terminal apparatus according to claim 7, wherein the display unit displays the electronic mails exchanged with the other party so as to add indications which discriminate the received electronic mail from the transmitted electronic mail.

9. A portable terminal apparatus, comprising:
a storage unit that stores a transmitted electronic mail and a received electronic mail;
a detection unit that detects an electronic mail related to the other party designated by the designation unit;
a telephone directory section configured to store the name of the other party and an electronic mail address of the other party so as to associate with each other; and
a display unit that displays a designated electronic mail by designating an arbitrary electronic mail while portions of opening sentences of the electronic mails exchanged with the other party detected by the detection unit are displayed so that the transmitted electronic mail and the received electronic mail which are exchanged with the other party, are displayed while being mixed in time sequence and while the electronic mails exchanged with the other party are displayed in list form.

10. The portable terminal apparatus according to claim 9, wherein the display unit retrieves a desired party by use of all or portions of the name or the electronic mail address stored in the telephone directory section, and selects the name of the retrieved party.

11. The potable terminal apparatus according to claim 2, wherein the, display unit displays titles of the electronic mails in list form as the list-form display.
